(19) United States
(12) Patent Application Publication
(10) Pub. No.: US 2022/0371324 A1
(43) Pub. Date: Nov. 24, 2022

(54) PURGING PRINTHEADS

(71) Applicant: HEWLETT-PACKARD DEVELOPMENT COMPANY, L.P., Spring, TX (US)

(72) Inventors: Josep Maria CUÑER UTGES, Sant Cugat del Valles (ES); Leyre HERNANDEZ MARTINEZ, Sant Cugat del Valles (ES)

(21) Appl. No.: 17/324,254

(22) Filed: May 19, 2021

(51) Int. Cl. B41J 2/14; B41J 2/165

(52) U.S. Cl. CPC B41J 2/14137; B41J 2/16579

(57) ABSTRACT

An example method of purging filler fluid from a printhead of a printing device includes applying a plurality of energy levels to a resistor coupled to the printhead. In addition, the method includes determining a temperature profile of a fluid within the printhead while applying the plurality of energy levels. Further, the method includes characterizing the fluid based on the temperature profile.

### BACKGROUND

A printing device may include a printhead for emitting liquid printing agent (e.g., ink) onto a print medium (e.g., paper, cardboard, a substrate). In some instances, a printhead may be a “universal” printhead that may be used within a printing device to emit different colors of liquid printing agent.

### BRIEF DESCRIPTION OF THE DRAWINGS

Various examples will be described below referring to the following figures:

FIG. 1 shows a printing device including a printhead and controller that is to purge a filler fluid from the printhead according to some examples;

FIG. 2 is a chart showing temperature profiles of a filler fluid and liquid printing agent within a printhead for a plurality of resistor input energies according to some examples;

FIG. 3 is a block diagram of a method for purging a printhead according to some examples; and

FIG. 4 is a block diagram of machine-readable instructions for purging a printhead according to some examples.

### DETAILED DESCRIPTION

A printhead may be used to emit liquid printing agent onto a surface of print medium within a printing device. A printhead (e.g., such as a universal printhead) may be installed within the printing device during an initial installation thereof, or when replacing a worn or damaged printhead therein. Regardless, when a universal printhead is shipped from a manufacturing site, it may be filled with a filler fluid that is different from liquid printing agent, and that is intended to protect the internal components of the printhead by, for instance, preventing dry-out. The filler fluid may be water-based and comprise solvents and/or surfactants. The filler fluid composition may depend on the specific design and specifications of the printhead; however, in general, the filler fluid may have a higher density and viscosity than the liquid printing agent that may flow within the printhead during a printing operation.

Thus, examples disclosed herein include systems and methods for characterizing a fluid within a printhead. In some examples, the systems and methods include characterizing the fluid based on a temperature profile of the fluid that may be determined by emitting drops from the printhead at a plurality of energy levels. In some examples, the systems and methods may be used for distinguishing filler fluid from liquid printing agent within a printhead.

After installing the printhead within the printing device, but before performing a printing operation, the filler fluid is purged and replaced with liquid printing agent (e.g., the liquid printing agent of the selected color). However, due to differences in the filler fluid, the liquid printing agent, the design of the printhead, and other variances, it can be difficult to accurately and consistently purge all (or substantially all) of the filler fluid from the printhead without undue waste of the liquid printing agent. Insufficient purging of the filler fluid may result in degraded printing operations (e.g., via degraded color, image clarity) due to mixing of unacceptable levels of the filler fluid within the liquid printing agent.

Accordingly, examples disclosed herein also include systems and methods for purging a filler fluid from the printhead that more accurately and consistently determine when all (or substantially all or a sufficient proportion) of a filler fluid has been removed. In some examples, the systems and methods include determining a temperature profile of the fluid within the printhead while emitting drops of fluid therefrom by applying pulses to the printhead's resistor at a plurality of energy levels. The systems and methods may then determine whether the filler fluid has been purged from the printhead based on the temperature profile (or values, properties, or characteristics thereof). Therefore, through use of the example systems and methods disclosed herein, a printing device may more accurately and consistently purge filler fluid from a printhead.

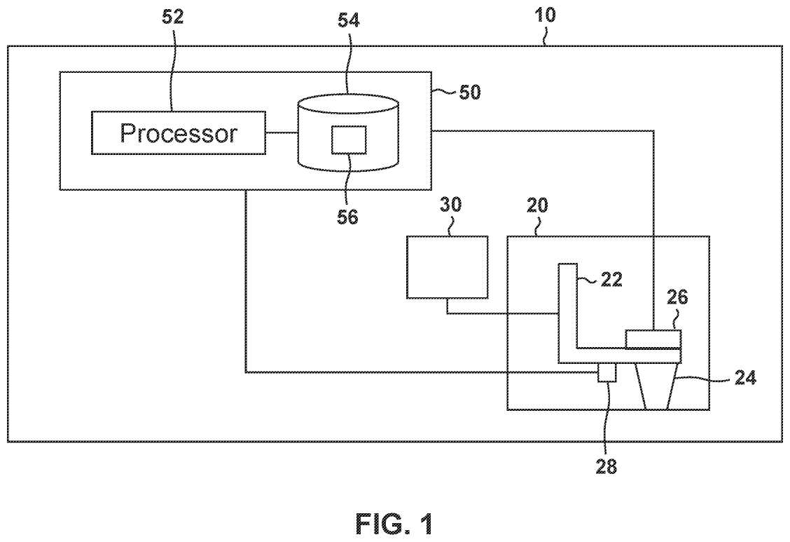

Referring now to FIG. 1, a printing device 10 according to some examples is shown. Printing device 10 may comprise a printer that is to print images on print medium (e.g., paper).

Printing device 10 includes a printhead 20 for emitting liquid printing agent (e.g., ink) onto a surface of the print medium (not shown) during operations. The printhead 20 includes an internal fluid passage 22 that is in communication with a nozzle 24. In some examples, the printhead 20 may include a plurality of nozzles 24 for emitting liquid printing agent from fluid passage 22 during operations.

Printhead 20 also includes a resistor 26 and a temperature sensor 28. The resistor 26 may comprise any suitable electrically resistive device (e.g., such as a thin-film resistor) that may output heat energy when energized with electric current. The resistor 26 may be positioned within or adjacent to the fluid passage 22. In some examples, the resistor 26 (or a portion thereof) may be in contact with fluid (e.g., filler fluid, liquid printing agent) disposed within the fluid passage 22, adjacent to the nozzle 24.

During operations, the resistor 26 may be energized with electric current, so that resistor 26 emits heat energy into the fluid within fluid passage 22 of printhead 20. Eventually, the fluid within fluid passage 22 may vaporize and form a bubble (or bubbles) that are expelled out of the nozzle 24. Emission of the bubble from the nozzle 24 may then generate a sufficient negative pressure at the nozzle 24 to draw out a drop (or drops) of fluid that may then be emitted from the printhead 20 (e.g., and onto the print medium). In this manner fluid may be selectively and controllably emitted from printhead 20.

During a printing operation, when the fluid being emitted from printhead 20 comprises liquid printing agent, the liquid printing agent may be provided to printhead 20 from a reservoir 30 that is fluidly coupled to printhead 20. In some examples, the reservoir 30 may be positioned within printing device 10 along with printhead 20. Alternatively, in some examples, reservoir 30 may be positioned separately or outside of printing device 10.

Referring still to FIG. 1, the printhead 20 also includes a temperature sensor 28 (e.g., thermocouple, thermistor) that is to detect the temperature within the printhead 20. In particular, the temperature sensor 28 may detect the temperature of the fluid within the fluid passage 22, proximate resistor 26 and/or nozzle 24. The temperature sensor 28 may comprise a die temperature sensor for the printhead 20 in some examples.

As previously described, when printhead 20 is initially used (and/or installed) within printing device 10, the printhead 20 (e.g., particularly fluid passage 22) may be filled with a filler fluid. As a result, printing device 10 may perform a purging operation to remove (or purge) the filler fluid from the printhead 20 and replace it with liquid printing agent provided from reservoir 30. Thus, printing device 10 includes a controller 50 that is coupled to both the resistor 26 and the temperature sensor 28 that may direct and perform a purging operation for printhead 20 according to the examples disclosed herein.

The controller 50 includes a processor 52 and a memory 54 coupled to processor 52. The processor 52 may comprise any suitable processing device, such as a microcontroller, central processing unit (CPU), graphics processing unit (GPU), timing controller (TCON), a scaler unit. The processor 52 executes machine-readable instructions (e.g., machine-readable instructions 56) stored on memory 54, thereby causing the processor 52 (and, more generally, controller 50 and printing device 10) to perform some or all of the actions attributed herein to the processor 52. In general, processor 52 fetches, decodes, and executes instructions (e.g., machine-readable instructions 56). In addition, processor 52 may also perform other actions, such as, making determinations, detecting conditions or values, etc., and communicating signals. If processor 52 assists another component in performing a function, then processor 52 may be said to cause the component to perform the function.

The memory 54 may comprise volatile storage (e.g., random access memory (RAM)), non-volatile storage (e.g., flash storage, etc.), or combinations of both volatile and non-volatile storage. Data read or written by the processor 52 when executing machine-readable instructions 56 can also be stored on memory 54. Memory 54 may comprise “non-transitory machine-readable medium.”

The processor 52 may comprise one processing device or a plurality of processing devices that are distributed within printing device 10. Likewise, the memory 54 may comprise one memory device or a plurality of memory devices that are distributed within the printing device 10. In some examples, controller 50 (or a component or components thereof) may be positioned within another electronic device (e.g., desktop computer, laptop computer, tablet computer, smartphone, server) that is separate from but is in communication (e.g., wired and/or wireless communication) with the printing device 10.

As previously described, the systems and methods disclosed herein may determine whether filler fluid has been purged from the printhead 20 (e.g., particularly fluid passage 22) based on a temperature profile within the printhead 20. In particular, during a filler fluid purging operation, the controller 50 may energize the resistor 26 (or cause the resistor 26 to be energized) with electric pulses at a plurality of energy levels (e.g., in micro Joules—μJ) for a period of time. The electric pulses to the resistor 26 may cause fluid within the fluid passage 22 to be emitted from nozzle 24 via the vaporization process previously described above.

Simultaneously with energizing the resistor 26, the controller 50 may detect the temperature of the fluid within the printhead 20 (e.g., particularly within fluid passage 22) via the temperature sensor 28 to determine a temperature profile within the printhead 20 over the range of energy levels provided to the resistor 26 via the electric pulses. Based on this temperature profile, the controller 50 may determine whether the fluid within the printhead 20 (and specifically within the fluid passage 22) is filler fluid or liquid printing agent.

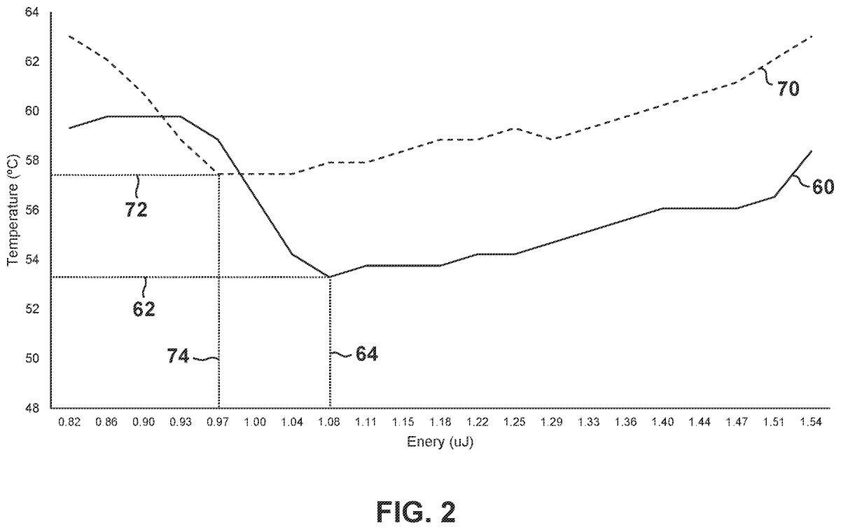

Referring now to FIG. 2, example temperature profiles for filler fluid and liquid printing agent within a fluid passage (e.g., fluid passage 22) of a printhead (e.g., printhead 20) are shown. In particular, FIG. 2 depicts a first temperature profile 60 for filler fluid and a second temperature profile 70 for liquid printing agent. The temperature profiles 60, 70 extend along a range (or plurality of) input pulse energy levels (in μJ) for a resistor (e.g., resistor 26) of the printhead. In particular, and referring briefly again to FIG. 1, the temperature profiles 60, 70 of FIG. 2 may be produced using the printhead 20 by providing input electric pulses to the resistor 26 within the range of energy levels depicted in FIG. 2, and measuring (e.g., via the temperature sensor 28) the corresponding temperature (e.g., in degrees Celsius) within fluid passage 22. In some examples, a plurality of pulses are provided to resistor 26 at each energy level to emit a specified number of drops from nozzle 24, and the temperature within fluid passage 22 may be measured, via temperature sensor 28, for one, some, or all of the pulses at each applied energy level. For instance, in some examples, a temperature measurement is made for each pulse at a given energy level, and an average is computed (e.g., by controller 50) to produce the temperature that is plotted for the temperature profile (e.g., temperature profile 60, 70) at the corresponding energy level.

Referring specifically again to FIG. 2, each temperature profile 60, 70 has a minimum temperature 62, 72, respectively within the plurality of input energies. The energy levels 64, 74 associated with the minimum temperatures 62, 72, respectively, may be the most thermally efficient energy levels for outputting the corresponding fluid from the printhead (e.g., printhead 20) during operations. The energy levels 64, 74 associated with the minimum temperatures 62, 72, respectively, may be referred to as the “turn-on pulse” or TOP for the corresponding temperature profiles 60, 70.

As can be see in the chart of FIG. 2, the TOPs 64, 74 are characteristically different for filler fluid and liquid printing agent. In particular, the TOP 64 for the filler fluid is greater than the TOP 74 for the liquid printing agent. Without being limited to this or any other theory, the difference in TOPs 64, 74 for the filler fluid and liquid printing agent may be due to the differences in viscosity of the two fluids. In particular, these different viscosities may cause differences in the energy for emitting one drop through the nozzle 24, which in turn may affect the temperature profiles 60, 70. It has been found that this difference generally applies to filler fluids and liquid printing agents, such that the TOP of the fluid within the printhead 20 may be utilized (e.g., by controller 50) to characterize the fluid as either filler fluid or liquid printing agent.

More specifically, referring now to FIGS. 1 and 2, during a filler fluid purging operation within printing device 10, controller 50 may initially emit drops of the filler fluid out of the printhead 20. The controller 50 may emit a specified number of drops (e.g., determined based on the number of electrical pulses provided to the resistor 26) and/or may emit drops of the filler fluid from nozzle 24 for a specified period of time. Next, controller 50 may determine the temperature profile of the fluid disposed within fluid passage 22 so as to determine whether the filler fluid has been fully purged therefrom (and is therefore replaced with liquid printing agent).

In particular, the controller 50 may emit drops of fluid from nozzle 24 of printhead 20 at a plurality of input energy levels (e.g., applied to resistor 26) and simultaneously measure the temperature within fluid passage 22 via temperature sensor 28 to produce a temperature profile like the temperature profiles 60, 70 shown in FIG. 2 and previously described. The controller 50 may then determine the TOP (e.g., TOPs 64, 74 previously described) based on the temperature profile, and may analyze the TOP in order to determine whether the fluid within the fluid passage 22 is filler fluid or liquid printing agent.

For instance, in some examples, the controller 50 may compare the TOP for the determined temperature profile to a threshold. The threshold may be selected to be characteristic of the general difference in the TOPs for filler fluid and liquid printing agent previously described above. In some examples, the threshold may be selected such that if the TOP of the determined temperature profile is greater than the threshold, one may determine that the fluid within the fluid passage 22 is filler fluid, and if the TOP of the determined temperature profile is less than the threshold, one may determine that the fluid within the fluid passage 22 is liquid printing agent.

In some examples, the controller 50 may generate a plurality of temperature profiles over a period of time by repeating the procedure described above (e.g., providing energy pulses to the resistor 26 and emitting drops of fluid from nozzle 24 while measuring the corresponding temperature). The controller 50 may then determine a variance (or delta) for the TOPs for the successive temperature profiles and compare this variance to a threshold to determine when all (or substantially all or a sufficient portion) of the filler fluid has been purged from fluid passage 22. If, for instance, the variance of the TOPs for successive temperature profiles is above the threshold, it may serve as an indication that the composition of the fluid is actively changing (e.g., from filler fluid to liquid printing agent), and as a result, the purging operation may continue. If, on the other hand, the variance of the TOPs for successive temperature profiles within the fluid passage 22 is below the threshold, it may indicate that the fluid within the fluid passage 22 is entirely (or mostly) comprised of liquid printing agent such that the purging operation may be ceased.

Thus, in the manner described, controller 50 may accurately determine whether the filler fluid has been purged from the fluid passage 22 of printhead 20. As a result, subsequent printing operations may not be degraded, without undue waste of liquid printing agent (e.g., by conducting the purging operation for too long).

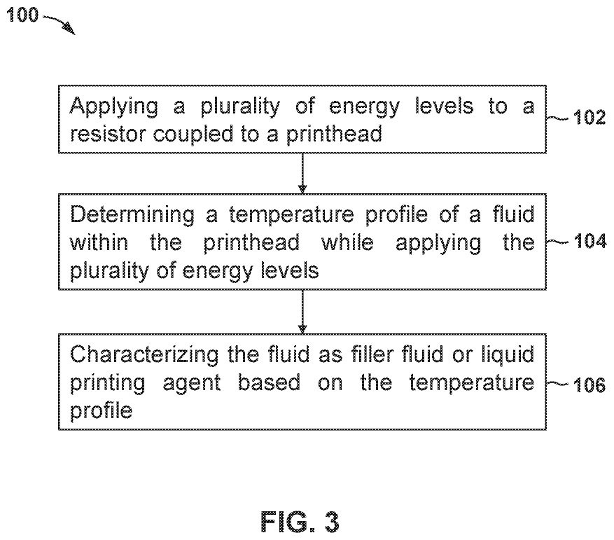

Referring now to FIG. 3, a method 100 of purging a printhead of a printing device according to some examples is shown. In some examples, method 100 may be performed by a controller within a printing device or other electronic device (e.g., such as controller 50 shown in FIG. 1). Accordingly, in describing the features of method 100, continuing reference is made to the printing device 10 shown in FIG. 1 and described above.

Method 100 includes applying a plurality of energy levels to a resistor coupled to a printhead at block 102. Taking the printing device 10 as an example, the energy levels may be applied to the resistor 26 by providing electric pulses to the resistor 26 at a plurality of different energy levels (or a range of energy levels) as previously described. Thus, one or a plurality of pulses may be applied to the resistor 26 at each energy level. In addition, in some examples the energy levels may be applied to cause the printhead 20 to emit fluid from a nozzle 24 via the heat emitted from the resistor 26 as a result of the pulses as previously described above. In some examples, a plurality of pulses may be applied to the resistor 26 at each applied energy level (of the plurality of energy levels) so as to allow a number (such as a specified number) of drops of fluid to be emitted from the nozzle 24 at each energy level.

Method 100 also includes determining a temperature profile of a fluid within the printhead while applying the energy levels at block 104. Again, taking the printing device 10 as an example, the temperature profile may be determined by taking temperature measurements within the fluid passage 22 of printhead 20 with temperature sensor 28 while emitting drops at the plurality of energy levels as previously described. Thus, in some examples, the temperature may be measured, via temperature sensor 28 at one (or a plurality of) the pulses applied to the resistor 26 as described above. In some examples, the temperature measurements may be an average of temperature measurements taken at the pulses for each applied energy level. The temperature profiles may be constructed as previously described, and may resemble the temperature profiles 60, 70 depicted in FIG. 2 in some examples.

Method 100 also includes characterizing the fluid as a filler fluid or liquid printing agent based on the temperature profile at block 106. In particular, block 106 may comprise determining the TOP for the temperature profile and characterizing the fluid as filler fluid or liquid printing agent based on the TOP as previously described.

In some examples, block 106 comprises comparing the TOP with a threshold which may be characteristic of the general difference between the TOP of filler fluid and the TOP of a liquid printing agent within the printhead. In some examples, if the TOP of the temperature profile is above the threshold, then the fluid within the printhead may be characterized as filler fluid, and if the TOP of the temperature profile is below the threshold, then the fluid within the printhead may be characterized as liquid printing agent.

In some examples, blocks 102 and 104 may be repeated a plurality of times such that a plurality of temperature profiles is determined for the fluid within the printhead over time. A time-based variance of the TOPs for the temperature profiles is then determined and compared with another threshold. The threshold for the TOPs may be selected to indicate when the fluid within the printhead is homogenous (or substantially or sufficiently homogenous) such that it may be determined that the purging operation is complete. More specifically, as previously described, if the TOP variance is below a threshold, this may indicate that the fluid within the printhead during the time period corresponding with the temperature profiles has remained substantially the same. Given that the amount of filler fluid within the printhead is finite, a homogenous fluid within the printhead following the emission of drops therefrom would indicate that all (or substantially all) of the filler fluid has been purged from the printhead and is now replaced with the liquid printing agent.

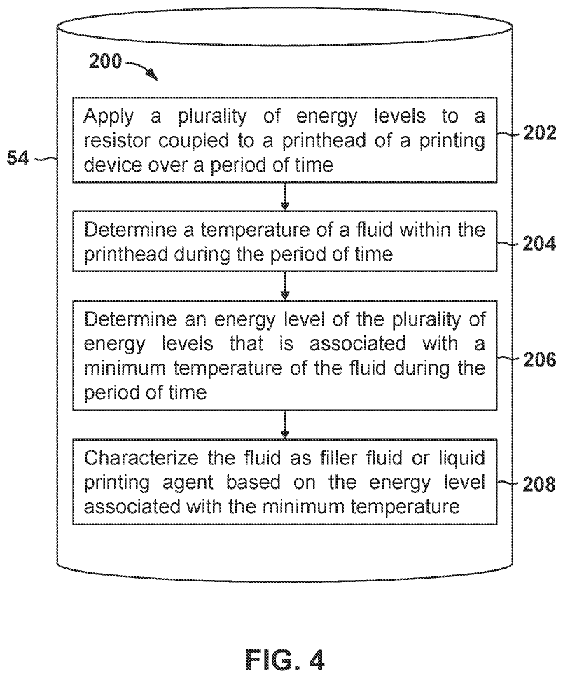

Referring now to FIG. 4, machine-readable instructions 200 for performing a purging operation for a printhead of a printing device according to some examples are shown. In some examples, the machine-readable instructions 200 may comprise an example of machine-readable instructions 56 stored on memory 54 and executed by processor 52 of controller 50 shown in FIG. 1. Thus, in describing machine-readable instructions 200, continuing reference will be made to printing device 10 shown in FIG. 1.

Machine-readable instructions 200 includes applying a plurality of energy levels to a resistor coupled to a printhead of a printing device over a period of time at block 202. For instance, the plurality of energy levels may be applied in the manner previously described herein (e.g., such as is described above for block 102 of method 100 in FIG. 3). In addition, machine-readable instructions 200 include determining a temperature of a fluid within the printhead during the period of time at block 104. As previously described for printing device 10, the temperature within the fluid passage 22 of printhead 20 may be measured via temperature sensor 28. The temperature may be measured at block 204 in the manner previously described herein (e.g., such as is described at block 104 of method 100 in FIG. 3).

Machine-readable instructions 200 also include determining an energy level of the plurality of energy levels that is associated with a minimum temperature of the fluid during the period of time at block 206. The energy level associated with the minimum temperature may comprise the TOP of a temperature profile that is determined using the temperature measurements and applied energy levels from blocks 202 and 204. Thus, the TOP of the fluid with the printhead may be determined in the manner previously described herein (e.g., TOPs 64, 74 shown in FIG. 2).

Machine-readable instructions 200 also include characterizing the fluid as filler fluid or liquid printing agent based on the energy level associated with the minimum temperature at block 208. The fluid may be characterized using the minimum temperature (or TOP) determined at block 206 via the manner described herein. Thus, the minimum temperature (or a variance thereof over time) may be compared to a threshold to determine whether the fluid within the printhead comprises filler fluid or liquid printing agent.

The examples disclosed herein include systems and methods for characterizing a fluid within a printhead. In addition, in some examples, the systems and methods comprise systems and methods for purging a filler fluid from a printhead that more accurately and consistently determine when all (or substantially all or a sufficient proportion) of a filler fluid has been removed. Therefore, through use of the example systems and methods disclosed herein, a printing device may more accurately and consistently purge filler fluid from a printhead.

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the discussion above and in the claims, the terms “including” and “comprising” are used in an open-ended fashion, and thus should be interpreted to mean “including, but not limited to . . . .” Also, the term “couple” or “couples” is intended to be broad enough to encompass both indirect and direct connections. Thus, if a first device couples to a second device, that connection may be through a direct connection or through an indirect connection via other devices, components, and connections. In addition, as used herein, the terms “axial” and “axially” generally mean along or parallel to a given axis (e.g., central axis of a body or a port), while the terms “radial” and “radially” generally mean perpendicular to the given axis. For instance, an axial distance refers to a distance measured along or parallel to the axis, and a radial distance means a distance measured perpendicular to the axis.

As used herein, including in the claims, the word “or” is used in an inclusive manner. For example, “A or B” means any of the following: “A” alone, “B” alone, or both “A” and “B.” In addition, when used herein including the claims, the word “generally” or “substantially” means within a range of plus or minus 10% of the stated value.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. A method of purging filler fluid from a printhead of a printing device, the method comprising:
applying a plurality of energy levels to a resistor coupled to the printhead;
determining a temperature profile of a fluid within the printhead while applying the plurality of energy levels; and
characterizing the fluid based on the temperature profile.

2. The method of claim 2, wherein characterizing the fluid comprises characterizing the fluid as filler fluid or liquid printing agent based on the temperature profile.

3. The method of claim 2, comprising:
emitting the fluid from the printhead while applying the plurality of energy levels to the resistor; and
determining a minimum temperature along the temperature profile,
wherein characterizing the fluid comprises characterizing the fluid as filler fluid or liquid printing agent based on the minimum temperature.

4. The method of claim 3, wherein characterizing the fluid comprises comparing an energy level associated with the minimum temperature to a threshold.

5. The method of claim 4, wherein characterizing the fluid comprises determining that the fluid is filler fluid when the energy level associated with the minimum temperature is above the threshold.

6. The method of claim 3, wherein characterizing the fluid comprises:
repeatedly applying the plurality of energy levels of the resistor and determining the temperature profile of the fluid such that a plurality of temperature profiles are determined over a period of time; and
comparing a variance of the energy level associated with the minimum temperature for the plurality of temperature profiles with a threshold.

7. The method of claim 6, wherein characterizing the fluid comprises determining that the fluid is liquid printing agent when the variance is below the threshold.

8. A printing device, comprising:
a printhead;
a resistor coupled to the printhead;
a temperature sensor coupled to the printhead; and
a controller coupled to the resistor and the temperature sensor, wherein the controller is to:
apply a plurality of energy levels to the resistor over a period of time;
determine a minimum temperature of a fluid within the printhead based on an output from the temperature sensor during the period of time; and
characterize the fluid as liquid printing agent based on the minimum temperature.

9. The printing device of claim 8, wherein the plurality of energy levels are to cause the fluid to be emitted from the printhead.

10. The printing device of claim 9, wherein the controller is to characterize the fluid by comparing an energy level of the plurality of energy levels that is associated with the minimum temperature with a threshold.

11. The printing device of claim 10, wherein the controller is to:
determine that the fluid is filler fluid if the energy level that is associated with the minimum temperature is above the threshold; and
determine that the fluid is liquid printing agent if the energy level that is associated with the minimum temperature is below the threshold.

12. The printing device of claim 8, wherein the controller is to:
repeatedly apply the plurality of energy levels of the resistor and determine a temperature profile of the fluid such that a plurality of temperature profiles are determined over a period of time; and
compare a variance of the energy level associated with the minimum temperature for the plurality of temperature profiles with a threshold.

13. The printing device of claim 12, wherein the controller is to determine that the fluid is liquid printing agent when the variance is below the threshold.

14. A non-transitory, machine-readable medium comprising instructions that when executed by a processor, cause the processor to:
apply a plurality of energy levels to a resistor coupled to a printhead of a printing device over a period of time;
determine a temperature of a fluid within the printhead during the period of time;
determine an energy level of the plurality of energy levels that is associated with a minimum temperature of the fluid during the period of time; and
characterize the fluid as filler fluid or liquid printing agent based on the energy level associated with the minimum temperature.

15. The non-transitory, machine-readable medium of claim 14, wherein the fluid is emitted from the printhead as a result of applying the plurality of energy levels to the resistor.

16. The non-transitory, machine-readable medium of claim 14, wherein the instructions, when executed by the processor, cause the processor to compare the energy level associated with the minimum temperature to a threshold.

17. The non-transitory, machine-readable medium of claim 16, wherein the instructions, when executed by the processor, cause the processor to determine that the fluid is filler fluid when the energy level associated with the minimum temperature is above the threshold.

18. The non-transitory, machine-readable medium of claim 16, wherein the instructions, when executed by the processor, cause the processor to determine that the fluid is liquid printing agent when the energy level associated with the minimum temperature is below the threshold.

19. The non-transitory, machine-readable medium of claim 14, wherein the instructions, when executed by the processor, cause the processor to:
repeatedly apply the plurality of energy levels of the resistor and determine a temperature profile of the fluid such that a plurality of temperature profiles are determined; and
compare a variance of the energy level associated with the minimum temperature for the plurality of temperature profiles with a threshold.

20. The non-transitory, machine-readable medium of claim 19, wherein the instructions, when executed by the processor, cause the processor to determine that the fluid is liquid printing agent when the variance is below the threshold.
